(19) United States
(12) Patent Application Publication
(10) Pub. No.: US 2009/0268573 A1
(43) Pub. Date: Oct. 29, 2009

(54) OPTICAL DISC RECORDER AND VIBRATION SENSITIVE CONTROL METHOD

(75) Inventors: Yen-Hsu Chen, Tu-Cheng (TW); Huan-Chieh Tseng, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/109,355

(22) Filed: Apr. 25, 2008

(30) Foreign Application Priority Data
Apr. 26, 2007 (CN) 200710200513.7

(51) Int. Cl. G11B 7/12

(52) U.S. Cl. 369/47.53; G9B/7.097

(57) ABSTRACT

According to one aspect, an optical recorder for recording data onto a disc includes a shock detector. The shock detector is used for determining whether the optical recorder is vibrated based on a servo error signal and generating a control signal. The control signal is used for interrupting recording data onto the disc when the optical recorder is vibrated.

### BACKGROUND

1. Field of the Invention

This invention relates to an optical disc recorder and a method for controlling recording to the optical disc.

2. Description of Related Art

Optical recorders for recording data onto recordable optical discs are widely used. Recordable discs, such as DVD-R/RW, DVD+R/RW, and CD-R/RW, are popular optical storage media in the consumer electronics market. A typical optical recorder uses a laser beam to record the data onto a disc rotated by a spindle motor of the optical recorder. The laser beam is emitted from an optical pick up head that is moveable along a radial direction of the disc.

The optical recorder is a vibration-sensitive device as the optical disc is rotating and the optical pick up head is moving when the optical recorder records data onto the optical disc. If the optical recorder is struck, the laser beam of the optical pick up head may deviate from a track predefined on the optical disc. Accordingly, the recording quality is degraded. Generally, the optical recorder is widely used in many types of portable electronic devices, such as notebook computers, digital video recorders, etc. These portable electronic devices are frequently struck or subjected to sudden movements and the recording quality of the optical disc may be affected.

Therefore, an optical disc recorder and a method for controlling the recording of optical discs are desired.

### SUMMARY

A method for recording data onto a disc includes the steps of: receiving a reflected laser beam reflected from the disc and generating a servo error signal according to the reflected laser beam; determining whether the optical recorder is vibrated based on the servo error signal; and generating a control signal for interrupting recording data onto the disc when the optical recorder is vibrated.

An optical recorder for recording data onto a disc includes a shock detector. The shock detector is used for determining whether the optical recorder is vibrated based on a servo error signal and generating a control signal. The control signal is used for interrupting recording data onto the disc when the optical recorder is vibrated.

Other systems, methods, features, and advantages of the present optical recording and/or reproducing device will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present optical disc recorder can be better understood with reference to the following drawings. The components in the drawings are not necessarily drawn to scale, emphasis instead being placed upon clearly illustrating the principles of the present device. Moreover, in the drawings, like reference numerals designate corresponding parts throughout the several views.

FIG. 1 is a block diagram of an optical recorder.

FIG. 2 is a schematic diagram of a track defined on an optical disc and laser spots focused on the optical disc.

FIG. 3 is a block diagram of an optical recorder in accordance with an exemplary embodiment.

FIG. 4 is a waveform chart showing a relationship between a servo error signal and a comparison result signal.

FIG. 5 is a block diagram of a shock detector.

FIG. 6 is a waveform chart showing relationships among a servo error signal, a comparison result signal, and a delayed signal.

FIG. 7 is a block diagram of an optical recorder in accordance with another exemplary embodiment.

FIG. 8 is a flow chart of a method for controlling a process of recording a disc.

### DETAILED DESCRIPTION OF THE EMBODIMENTS

Reference will now be made to the drawings to describe preferred embodiments of a present optical recorder, in detail.

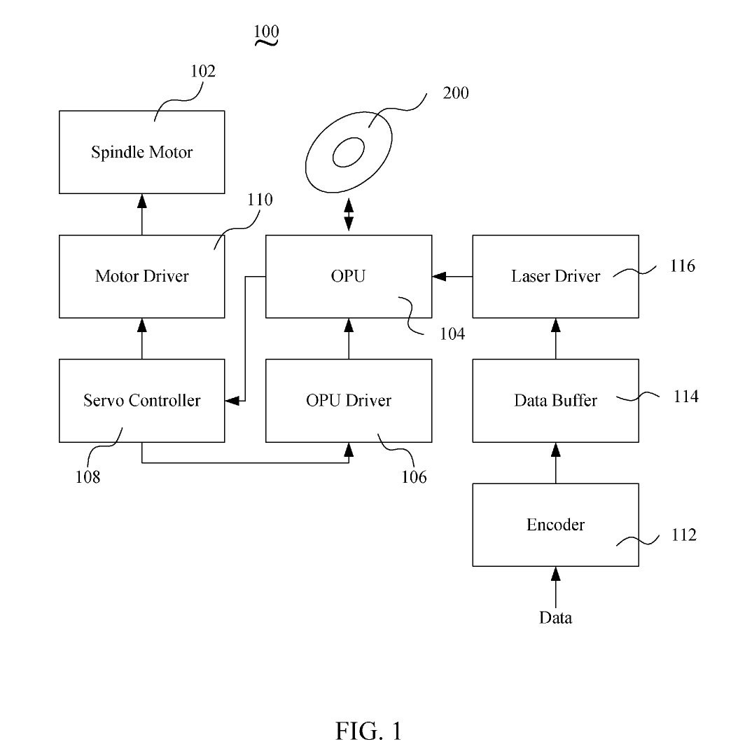

Referring to FIG. 1, a recorder 100 for recording data onto a disc 200 is depicted. The recorder 100 includes a spindle motor 102 for rotating the disc 200, an optical pickup unit (OPU) 104 for emitting a laser beam onto the disc 200 so as to record the data to the disc 200, an OPU driver 106, a servo controller 108, and a motor driver 110. The OPU 104 is further used for receiving the laser beam reflected from the disc 200 and generating a servo error signal, such as a focusing error signal or a tracking error signal, according to the received laser beam. The servo error signal is transmitted to the servo controller 108 for further analysis. The servo controller 108 generates and sends servo controlling signals to the OPU driver 106 and the motor driver 110 based on the servo error signal.

In response to the servo controlling signals, the OPU driver 106 transmits OPU driving signals to the OPU 104 for adjusting the laser beam emitted by the OPU 104, for example, adjusting a focusing operation or a tracking operation for the laser beam. The motor driver 110 receives the servo controlling signals and generates motor driving signals for adjusting a rotating speed or changing a rotating mode of the spindle motor 102. There are various rotating modes of the spindle motor 102, such as constant linear velocity (CLV) mode, constant angular velocity (CAV) mode, partial constant angular velocity (P-CAV) mode, and zoned constant linear velocity (Z-CLV) mode.

The recorder 100 further includes an encoder 112, a data buffer 114, and a laser driver 116. The data that are going to be recorded on the disc 200 are encoded by the encoder 112 for complying with a recording standard, such as EFM (eight-to-fourteen modulation) or EFM plus. The encoded data are sent to the data buffer 114 for temporary storage. The laser driver 116 generates laser driving signals according to the encoded data stored in the data buffer 114 and transmits the laser driving signals to the OPU 104. The OPU 104 emits the laser beams based on the laser driving signals. Thus, the data are recorded on the disc 200.

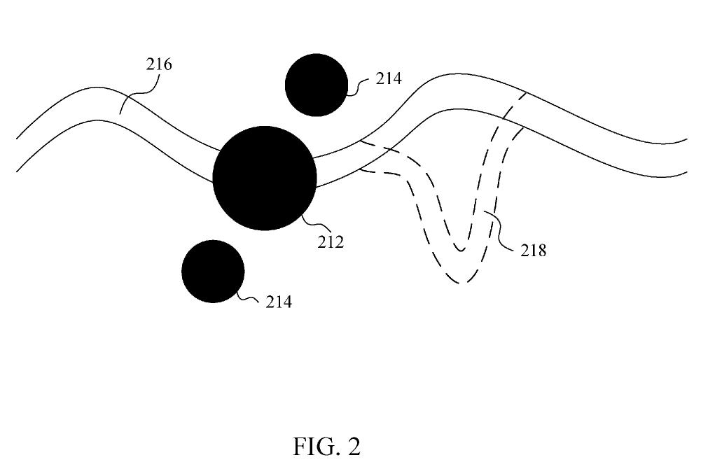

Referring to FIG. 2, the laser beams emitted from the OPU 104 includes a primary beam 212 and two secondary beams 214. The primary beam 212 is used for recording data to the disc 200. The two secondary beams 214 are distributed at two sides of the primary beam 212. Parts of the primary beam 212 and two secondary beams 214 are reflected by the disc 200 and then received by the OPU 104. By analyzing the reflected primary beam 212 and the reflected secondary beams 214, the focusing precision of the primary beam 212, on a predefined track 216 of the disc 200, can be determined.

Generally, the primary beam 212 will be moved along the track 216 when the disc 200 is rotated by the spindle motor 102. When the recorder 100 is subjected to a sudden acceleration the OPU 104 may deviate from its original position. Thus, the primary beam 212 may deviate from the predefined track 216 and may take the path 218. This will result in decrease recording speed, and may even result in data lost.

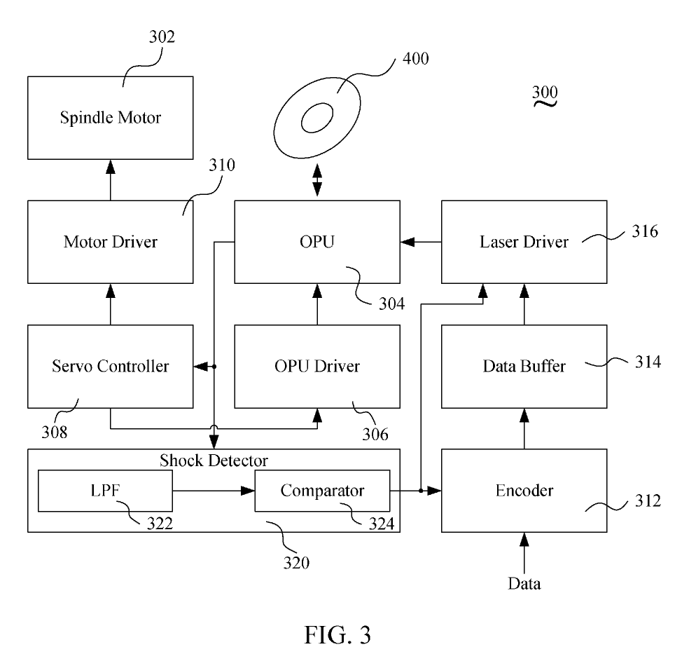

Referring to FIG. 3, a recorder 300 in accordance with an exemplary embodiment for recording data onto a disc 400 is illustrated. The recorder 300 includes a spindle motor 302 for rotating the disc 400, an optical pickup unit (OPU) 304 for emitting and receiving laser beams, an OPU driver 306 for driving the OPU 304 to move, a servo controller 308 for servo controlling, and a motor driver 310 for driving the spindle motor 302.

The recorder 300 further includes an encoder 312 for encoding data, a data buffer 314 for storing the encoded data, a laser driver 316 for driving the OPU 304 to emit laser beams, and a shock detector 320.

The shock detector 320 is associated with the OPU 304 for receiving a servo error signal to determine whether the recorder 300 is vibrated. If the shock detector 320 detects a sudden acceleration of the recorder 300, the shock detector 320 generates a control signal that signals the recorder 300 to interrupt recording. If the shock detector 320 detects that the shock of the recorder 300 no longer exists, the shock detector 320 generates the control signal that signals the 300 to resume recording.

The shock detector 320 includes a low pass filter (LPF) 322 and a comparator 324. The LPF 322 receives the servo error signal and passes a low-frequency signal in the servo error signal but attenuates (reduces the amplitude of) signals with frequencies higher than a cutoff frequency of the LPF 322. Thus high-frequency noise is filtered and the filtered servo error signal is transmitted to the comparator 324.

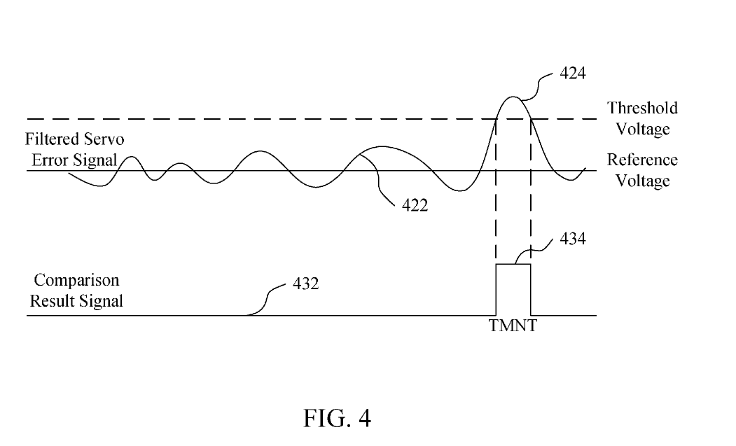

The comparator 324 is coupled to the LPF 322 for receiving the filtered servo error signal and comparing the filtered servo error signal with a predetermined threshold voltage, thus yielding a comparison result. The comparator 324 generates a comparison result signal according to the comparison result. Referring also to FIG. 4, the voltage of the filtered servo error signal fluctuates around a reference voltage. Generally, the voltage of the filtered servo error signal, such as signal portions labeled 422, is lower than the threshold voltage. When the recorder 300 is vibrated, which results in the primary beam 212 deviating from the track 216, the voltage of the filtered servo error signal (labeled with numeral 424) will become much higher than the threshold voltage. When the voltage of the filtered servo error signal is greater than the threshold voltage, the comparison result signal generated by the comparator 324 is represented with a high voltage level (labeled with numeral 434). In contrast, when the voltage of the filtered servo error signal is lower than the threshold voltage, the comparison result signal is represented with a low voltage level (labeled with numeral 432).

The comparison result signal generated by the comparator 324 is transmitted to the encoder 312 and the laser driver 316 as the control signal for controlling the recording process. When the control signal is represented with the low voltage level, the laser driver 316 continuously outputs the laser drive signals to the OPU 304 for driving the OPU 304 to emit laser beams. When the control signal is represented with the high voltage level, the process of outputting the laser drive signals to the OPU 304 is suspended.

The recorder 300 includes the shock detector 320 for determining whether the recorder 300 is vibrated based on the servo error signal and generates the control signal. The control signal is configured to interrupt recording data onto the disc 400 when the recorder 300 is vibrated.

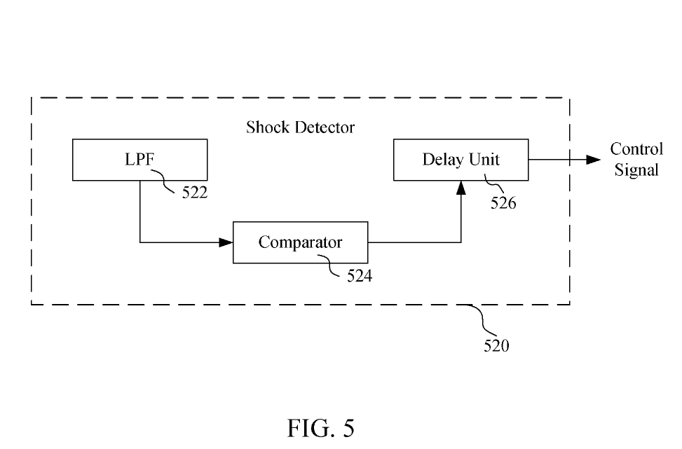

Referring to FIG. 5, another embodiment of a shock detector 520 is illustrated. The shock detector 520 includes a low-pass filter (LPF) 522, a comparator 524, and a delay unit 526.

The LPF 522 receives the servo error signal and passes the low-frequency signal in the servo error signal but attenuates (reduces the amplitude of) signals with frequencies higher than a cutoff frequency of the LPF 522. Thus high-frequency noise is filtered and the filtered servo error signal is transmitted to the comparator 524.

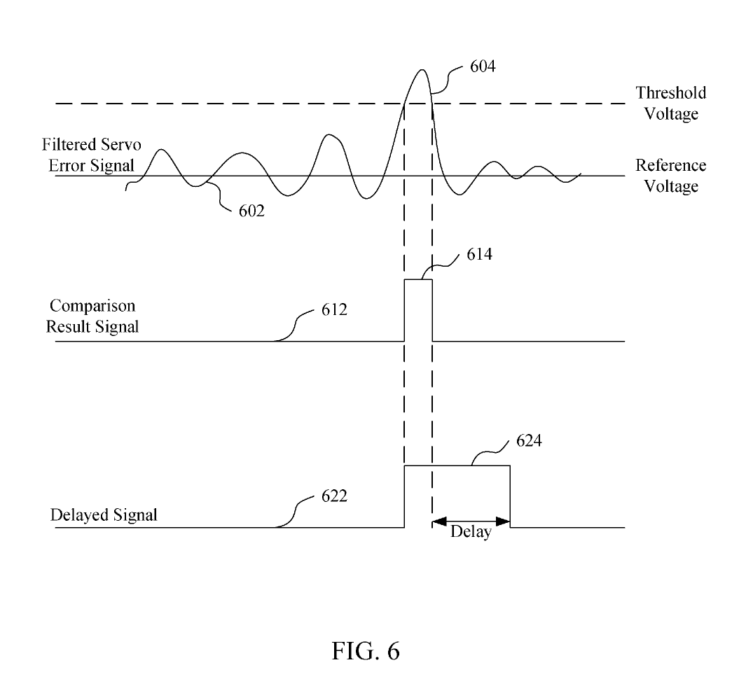

The comparator 524 is coupled to the LPF 522 for receiving the filtered servo error signal and comparing the filtered servo error signal with a predetermined threshold voltage. The comparator 524 generates a comparison result signal according to the comparison result. Referring also to FIG. 6, the voltage of the filtered servo error signals fluctuates around a reference voltage. Generally, the voltage of the filtered servo error signal is lower than the threshold voltage, such as signal portions labeled with numeral 602. If the recorder 300 is vibrated and the primary beam 212 deviates from the track 216, the voltage of the filtered servo error signal will become higher than the threshold voltage (labeled with numeral 604). If the voltage of the filtered servo error signal is greater than the threshold voltage, the comparison result signal generated by the comparator 524 is represented as a high voltage level (labeled with numeral 614). In contrast, if the voltage of the filtered servo error signal is lower than the threshold voltage, the comparison result signal is represented as low voltage level (labeled with numeral 612).

The comparison result signal is transmitted to the delay unit 526 for extending a period of the high voltage level 614 to generate a delayed signal. The delayed signal includes a low voltage level 622 and a high voltage level 624. The low voltage level 622 rises to the high voltage level 624 when the comparison result signal goes to a high level 614. However, on the falling edge of the high voltage level 614 of the comparison result signal, the high voltage level 624 of the delayed signal is extended by a predetermined delay. Thus a period of the high voltage level 614 is extended to generate the high voltage level 624 of the delayed signal.

The delayed signal generated by the delay unit 526 is transmitted to the encoder 312 and the laser driver 316 as the control signal for controlling the recording process. If the control signal is represented as low voltage level, the laser driver 316 continuously outputs the laser drive signals to drive the OPU 304 to emit laser beams. If the control signal is represented as high voltage level, the process of outputting the laser drive signals to the OPU 304 is suspended. In this embodiment, the high voltage level 614 of the comparison result signal is delayed and thus extended. If the recorder 300 is intermittently vibrated with short intervals, the process of recording would not be interrupted too frequently because the delayed high voltage level lasts for a relatively long time. Thus the recorder 300 is kept in a non-recording state when the recorder 300 is intermittently vibrated with short intervals.

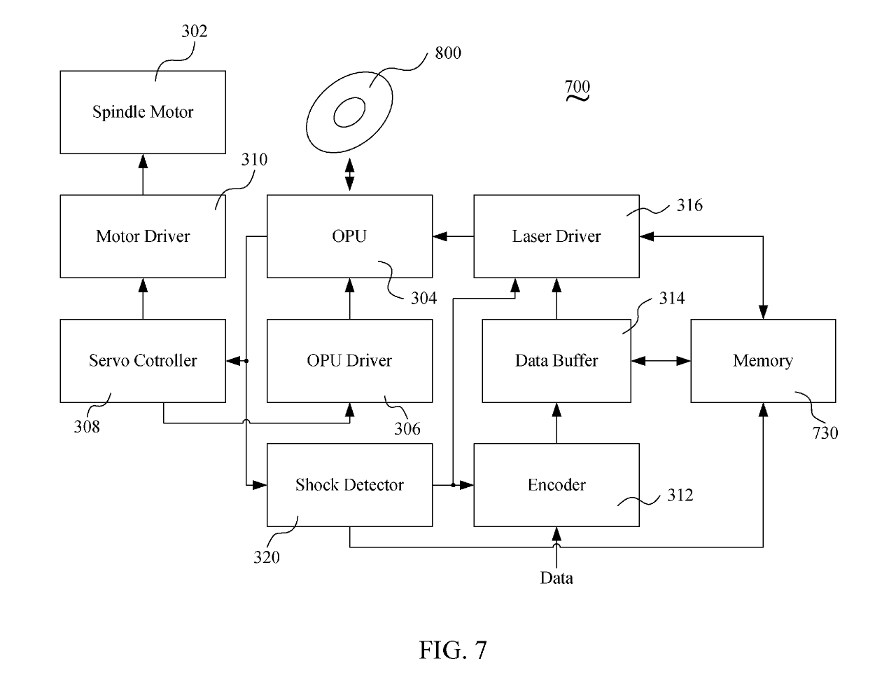

Referring to FIG. 7, another embodiment of a recorder 700 for recording data onto a disc 800 is illustrated. Comparing to the recorder 300 depicted in FIG. 3, the recorder 700 further includes a memory 730 for storing destination address of the data to be recorded before the recorder 700 is vibrated. The memory 730 is further used for storing physical address of the disc 800 for recording the data that is going to be recorded before the recorder 700 is vibrated. The memory 730 is coupled to the shock detector 320 for receiving the control signal. Once the control signal is represented as the high voltage level, the destination address and the physical address are transmitted to the memory for being temporarily stored. When the control signal falls to the low voltage level, the temporarily stored destination address and physical address are retrieved to resume the recording process.

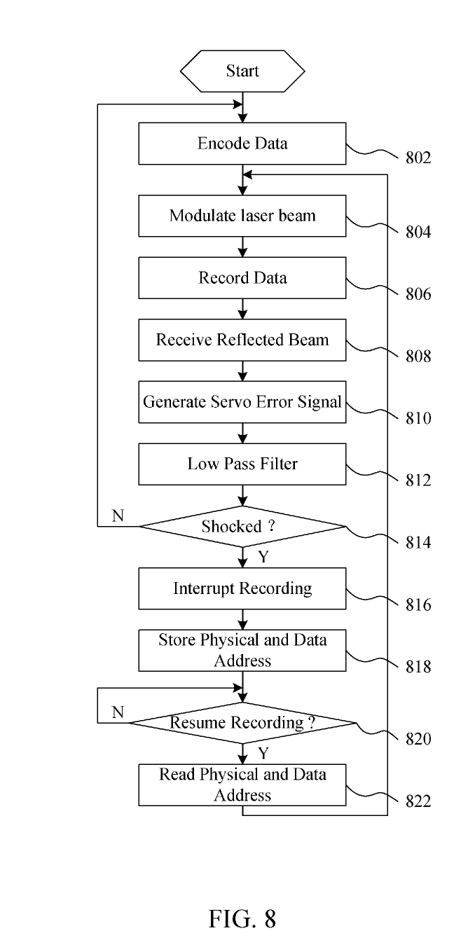

Referring to FIG. 8, a procedure of a method for controlling a recording process of the recorder 700 is illustrated.

In step 802, the data that are going to be recorded onto the disc 800 are encoded by the encoder 312 for complying with recording standard, such as EFM (eight-to-fourteen modulation) or EFM plus.

In step 804, the encoded data are transmitted to the data buffer 314 for temporary storage and the laser driving signals are generated according to the encoded data stored in the data buffer.

In step 806, the laser beams are emitted according to the laser driving signals and the laser beams are focused on the disc 800 to record the data.

In step 808, the OPU 304 receives reflected beams reflected from the disc 800.

In step 810, the OPU 304 generates servo error signals according to the received reflected beams.

In step 812, the servo error signals are transmitted to the low pass filter 522 for filtering out high-frequency noise from the servo error signals.

In step 814, the filtered servo error signal is compared with a predetermined threshold voltage to determined whether the recorder 700 is vibrated. If the filtered servo error signal is greater than the predetermined threshold voltage, that is, the recorder 700 is vibrated, the procedure goes to step 816. Or else, the procedure goes back to step 802.

In step 816, the process of recording is interrupted. The OPU 304 stops emitting the laser beams and the encoder 312 stops encoding data. Thus, the process of recording the disc 800 is interrupted

In step 818, the destination address of the data that is going to be recorded before the shock of the recorder 700 and the physical address of the disc 800 for recording the data are stored in the memory 730.

In step 820, if the recorder 700 is still being vibrated, the filtered servo error signal remains greater than the predetermined threshold voltage and the process of recording cannot be resumed. If it is detected that the recorder 700 is not vibrated, the recorder 700 resumes recording.

In step 822, the destination address and the physical address stored in the memory 730 are retrieved to resume the recording process.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An optical recorder for recording data onto a disc, the optical recorder comprising:
a spindle motor for rotating the disc;
a motor driver for driving the spindle motor;
an optical pick up head for emitting a laser beam to record data onto the disc and receiving a reflected laser beam reflected from the disc to generate a servo error signal according to the reflected laser beam;
an optical pick up driver for driving the optical pick up head to move;
a servo controller for receiving the servo error signal and controlling the motor driver and the optical pick up driver;
a laser driver for driving the optical pick up head to emit the laser beam; and
a shock detector for receiving the servo error signal and controlling the laser driver to stop driving the optical pick up head to emit the laser beam if it is determined that the optical recorder is vibrated based on the servo error signal.

2. The optical recorder as claimed in claim 1, wherein the shock detector comprises a low pass filter for receiving the servo error signal and filtering out high-frequency noise from the servo error signal.

3. The optical recorder as claimed in claim 2, wherein the shock detector further comprises a comparator coupled to the low pass filter for receiving the filtered servo error signal and comparing the filtered servo error signal with a predetermined threshold voltage to determine whether the optical recorder is vibrated.

4. An optical recorder for recording data onto a disc, the optical recorder comprising:
an optical pick up head for receiving a reflected laser beam reflected from the disc and generating a servo error signal according to the reflected laser beam; and
a shock detector for determining whether the optical recorder is vibrated based on the servo error signal and generating a control signal; wherein the control signal is configured for interrupting the recording of data onto the disc when the optical recorder is vibrated.

5. The optical recorder as claimed in claim 4, wherein the shock detector comprises a low pass filter for receiving the servo error signal and filtering out high-frequency noise from the servo error signal.

6. The optical recorder as claimed in claim 5, wherein the shock detector further comprises a comparator coupled to the low pass filter for receiving the filtered servo error signal and comparing the filtered servo error signal with a predetermined threshold voltage to determine whether the optical recorder is vibrated.

7. The optical recorder as claimed in claim 6, wherein the comparator generates a high voltage level when the optical recorder is vibrated.

8. The optical recorder as claimed in claim 7, wherein the detector further comprises a delay unit for extending a period of the high voltage level.

9. The optical recorder as claimed in claim 9, wherein the high voltage level is transmitted to the optical pick up head for interrupting the process of recording the disc.

10. The optical recorder as claimed in claim 4, further comprising a memory for storing a physical address of the disc for recording the data that is going to be recorded before the shock of the recorder.

11. The optical recorder as claimed in claim 10, wherein the memory is further configured for storing a destination address of the data that is going to be recorded before the shock of the recorder.

12. A method for recording data onto a disc, the method comprising:
receiving a reflected laser beam reflected from the disc and generating a servo error signal according to the reflected laser beam;
determining whether the optical recorder is vibrated based on the servo error signal; and
generating a control signal for interrupting recording data onto the disc when the optical recorder is vibrated.

13. The method as claimed in claim 12, further comprising: filtering out high-frequency noise from the servo error signal.

14. The method as claimed in claim 13, further comprising: comparing the filtered servo error signal with a predetermined threshold voltage to determine whether the optical recorder is vibrated.

15. The method as claimed in claim 14, further comprising: generating a high voltage level when the optical recorder is vibrated.

16. The method as claimed in claim 15, further comprising: extending a period of the high voltage level.

17. The method as claimed in claim 16, further comprising: transmitting the high voltage level to the optical pick up head for interrupting the process of recording the disc.

18. The method as claimed in claim 12, further comprising: storing a physical address of the disc for recording the data that is going to be recorded before the vibration of the recorder.

19. The method as claimed in claim 12, further comprising: storing a destination address of the data that is going to be recorded before the vibration of the recorder.

20. The method as claimed in claim 12, further comprising: resuming recording data onto the disc when the vibration of the optical recorder is absence.
